(19) United States
(12) Patent Application Publication
(10) Pub. No.: US 2026/0145376 A1
(43) Pub. Date: May 28, 2026

(54) Process for manufacturing of composite material by bulk molding compounds compressing for aerospace industry

(71) Applicant: VIETTEL GROUP, Ha Noi City (VN)

(72) Inventors: MINH TUAN HOANG, Ha Noi City (VN); SY THUY NGO, Nghe An Province (VN); TUAN MINH DO, Ha Noi City (VN); VAN NGOC NGUYEN, Ha Noi City (VN)

(73) Assignee: VIETTEL GROUP, Ha Noi City (VN)

(21) Appl. No.: 19/336,025

(22) Filed: Sep. 22, 2025

(30) Foreign Application Priority Data
Nov. 27, 2024 (VN) 1-2024-08914

(51) Int. Cl. B29C 48/00; B29C 43/00; B29C 48/28; B29K 45/00; B29K 63/00; B29K 67/00; B29K 277/00; B29K 307/04; B29K 309/08; B29L 31/30

(52) U.S. Cl. CPC B29C 48/0011; B29C 43/003; B29C 48/28; B29K 2045/00; B29K 2063/00; B29K 2067/00; B29K 2277/10; B29K 2307/04; B29K 2309/08; B29L 2031/3076

(57) ABSTRACT

A design for production method of composite materials that have the ability of heat insulation, ablation resistant, high reliability by bulk molding compound method, applied for specific, special parts in aerospace industry. The method comprises three main parts: (1) The production process for composite materials by bulk molding compound method; (2) The technique for bulk producing; (3) The testing method for ablation and static-pressure of final composite parts has been produced by bulk molding compound. The ingredients for this process is including of matrix resin: epoxy, phenolic and polyester; reinforcement fibre: Glass fibre (E-glass/S-glass), carbon, aramid; and some others additives, catalyst, binders. This is a simple, cost-effective method, easy to produce the composite parts with geometry diversity, easy for machining, final products have super-high strength, great heat insulation and ablation resistant.

### I. TECHNICAL FIELD OF PATENT

The present invention relates to a method for manufacturing advanced composite materials utilizing the bulk molding compound (BMC) compression molding technique. The composite material is formulated from a thermosetting resin matrix, such as phenolic resin, epoxy resin, or polyester resin, combined with reinforcing fibers—preferably glass fibers of the E-glass or S-glass type—and various functional additives. The resulting bulk molding compound is designed for the fabrication of components exhibiting enhanced thermal resistance, ablation resistance, electrical insulation, and other specialized properties.

This method offers an efficient and scalable solution for producing structurally complex parts with tailored mechanical and thermal characteristics. The BMC compression process enables high design flexibility, cost-effectiveness, and suitability for mass production while maintaining performance reliability under demanding thermal and environmental conditions.

### II. BACKGROUND OF THE INVENTION AND TECHNICAL STATUS

Composite materials are engineered from constituent components primarily comprising a matrix material, reinforcing fibers, and functional additives. These materials, which have experienced significant advancement since the late 20th century, offer a combination of superior properties such as low density, high mechanical, physical, and chemical strength, and the ability to be molded into complex geometries based on specific design requirements.

Due to these attributes, composite materials have become indispensable in advanced engineering applications, particularly in the aerospace and defense sectors. In modem aerospace systems—including missiles and space vehicles—components are often required to endure extreme thermal loads, high structural pressures, ablation environments, and stringent performance conditions that conventional materials cannot satisfy.

As a result, composite materials are extensively utilized in the fabrication of critical aerospace components such as aircraft fuselages, heatsink fins for tactical aircraft, rocket motor casings and nozzles, cryogenic fuel chambers for space shuttles, solar array panels, satellite structures, antennas, and more.

Numerous prior inventions have disclosed methods for fabricating composite materials intended for application in various aerospace components. These manufacturing techniques include, but are not limited to, filament winding, extrusion, open compression molding, lamination, and injection molding. The matrix materials commonly employed in such methods comprise epoxy resins, phenolic resins, and ethylene propylene diene monomer (EPDM), among others. These matrices are typically reinforced with high-performance fibers such as glass fibers, carbon fibers, or silica-based fibers to achieve the desired mechanical and thermal properties.

The following patents exemplify international developments related to the aforementioned fabrication techniques and material systems:
U.S. Pat. No. 4,232,843 dated on Nov. 11, 1980 shown the process of nozzle fabrication that use resin transfer molding technique. This method used phenolic resin as matrix material and reinforced by glass fibre, silica, asbestos. The disadvantage of this process is difficulty in controlling the flow of resin that could lead to the defects inside the materials.
Patent Publication US 2008/0241446 A1 dated on Feb. 10, 2008 described the method of producing the composite material by filament winding, extrusion, open compress molding that used polymer resin as matrix and reinforced by E-glass fibre. The composite fabricated has been used for case of rocket engine and wings of civil aircraft.
Patent WO 2008/121005 A1 dated on Sep. 10, 2008, World Intellectual Property Organization—WIPO, indicated that the wings of Boeing 777 and F-22 have been manufactured from composite materials that fabricated by resin transferring molding used epoxy resin as matrix and reinforced by carbon fibre.

Although numerous patents have been issued concerning the production of composite materials utilizing thermosetting resins and reinforcements such as glass fibers or carbon fibers through various manufacturing methods, none have provided a comprehensive technical disclosure specifically directed to the formulation, processing, and equipment design for bulk molding compounds (BMC) based on phenolic resins reinforced with glass fibers.

The present invention addresses this gap by introducing a novel, simplified, and cost-effective method for producing BMC-based composite parts. This method enables scalable mass production of components with diverse and complex geometries while delivering superior mechanical, physical, and chemical properties. The invention is particularly advantageous for high-performance applications where thermal resistance, dimensional stability, and structural integrity are critical.

### SUMMARY OF THE INVENTION

The purpose of this invention is to propose the technique to produce advanced composite materials with high ability of heat insulation, ablation resistant, high mechanical-physical-chemical reliability, used bulk molding compound method and applied in aerospace industry, that including: thermal insulation, nozzle for solid rocket engine, case, wings of aircraft, satellite, antenna, . . . . The process of this manufacture including many steps as follow: Step 1—Raw material preparation; Step 2—Raw material scaling; Step 3—Premix the raw material; Step 4—Final-mix materials; Step 5—Bulk extrusion; Step 6—Stock the bulk materials; Step 7—Bulk molding compound compress process to fabricate final composite, mould release, machining.

### BRIEF DESCRIPTION OF THE DRAWINGS

FIG. 1: The diagram of composite materials production;

FIG. 2: The diagram of bulk producing integrated with bulk molding compounds;

FIG. 3: The illustration of ablation test;

FIG. 4: The diagram of static-pressure testing;

FIG. 5: The design of mould for bulk molding compound technique; and

FIG. 6: The illustrating images of final product

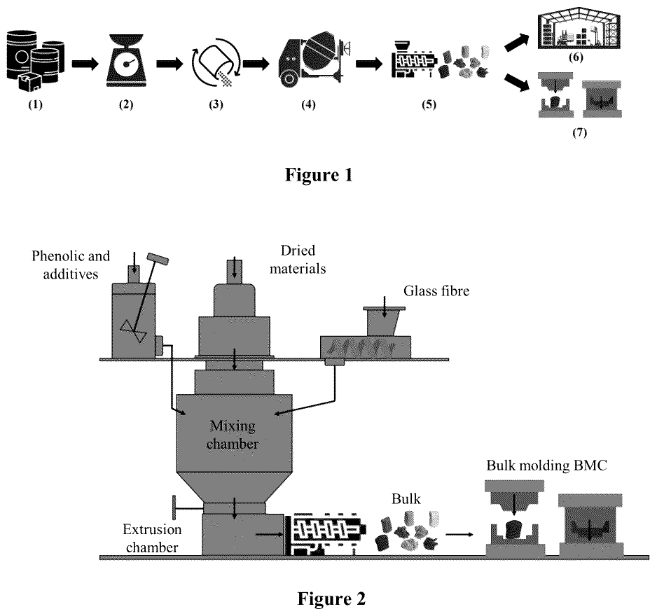

### DETAILED DESCRIBE OF THE INVENTION

The manufacture process:

### 1. The Process of Composite Producing by Bulk Molding Compound Technique

The component of raw materials for this process including of resin matrix, monomers, catalyst, binder, release agent, and fibre reinforcement. All these ingredients will be premixed, completed mix, extrusion to fabricate bulk materials, and then mould compressed to produce final products. The process is described detail as below.
Step 1: Raw materials are distracted from the warehouse, separately placed one by one to ensure that they will not be incidentally mixed to each other, get ready for ingredient scaling.
Step 2: Start to scale separately each raw material and pour into different container, labeled them, get ready for next step of process. Each raw material needs to be accurately scaled to ensure the minimum tolerant of production formula.
Step 3: The prepared raw materials are splitted into group by group that have same properties into one and pre-mixed. The dried-solid materials are mixed in alpha mixing type or equivalent. Resin matrix and other catalyst, binders, . . . are poured into stirring a mixing chamber to get the uniform blend. In another chamber, the reinforcement fibre is cut into small length and blown into convection mixing.
Step 4: All the pre-mixed materials are mixed carefully in a central chamber. The speed of the stirrer needs to ensure that it will not affect the structural reinforcement. Otherwise, it is needed to ensure anti-air gap inside the material after mixing.
Step 5: After mixing, the materials which are in the mixed well state are extracted into the chamber for bulk extrusion. The extruding machine operates, extrudes the materials out by the bulk form that has not been cured. The temperature for this mixing step is (50÷65)° C. within (15÷20) minutes that depends on the speed of stirring paddle.
Step 6: The bulk form materials after extruding are stored in a container with the suitable conditions and ready for any further steps.
Step 7: The bulk materials are transferred to the extrusion molding machine in order to form, compress and cure for final composite part as designed before. The temperature used for this process is (143÷171)° C. under the pressure of (27.6÷41.4) Mpa. The compressing period for this step is (3÷6) seconds. The composite part after curing is separated from mould with the support of a mould releasing agent. The composite part is next handled, machining to get the final requirement of the surface and final shape.

### 2. The Process of Producing Bulk Materials

Regarding to the producing technique mentioned above, the input materials are resin matrix, the inhibitor, binders, mould releasing agent, and the compound of many other catalysts and are mixed in a separate mixer chamber. The compound after pre-mixing is transferred into the mixing chamber with Sigma type paddle. Herein, all the materials including chopped glass fiber, are mixed to each other and form a paste state material that ready for bulk moulding process.

In this process, mixing resin and reinforcement fibre is one of the most practical steps that can determine the quality of final composite materials. If this step operates over the requirements, the structure of materials will be destroyed. On the other hand, if we finish this step by the designed point, the bulk material will not be consistent that leads to the ability of separate the resin and fibre part. Thereby, the quality of final composite materials will not reach the standard as desire. The investigation of mixing period is, therefore, important and needs to be estimated well. This point depends on the mixing chamber type, the pre-heating speed, and mixing temperature. The optimal temperature for mixing process in this technique is (120÷150)° F. or (50÷65)° C.

The bulk extrusion step has been added into this process with the purpose of removing the trapped bubbles inside the bulk formed materials, condensate bulk compound and pre-form the bulk materials in order to easily handle for further steps. The Ram style extrusion compressing has been used for this technique to form a high density bulk with geometric diversity but the structure of initial materials is still safe.

Resin, monomer, catalyst system, thickener, filler, mold release agent, and high-ratio reinforcing fiber are the major raw ingredients used in bulk injection molding technique to manufacture composite materials. The charges vary according to the intended purpose and technical specifications of the final product. The filler for resin can be added into the producing formula up to 60%. The optimal percentage of glass fibre used in this process is 15%÷20%. The size of chopped glass fibre is 0.25 inch. All the other ingredients such as catalysts, thickeners, . . . have also added to the final producing formula in order to gain the mechanical—physical—chemical properties of final composite materials that depends on the final using purposes of product. Table 1 indicates three producing formula for three use purposes.

Depending on the area of application, the input resin and reinforcing fibre could be replace by many other ready types. Table 2 shows some other popular resin with its unique properties. Besides, Table 3 indicates some kinds of reinforcing fibre that could be used for composite producing by bulk moulding compress process. The combination of all those ingredients will help to produce many kind of composite materials that can reach the diverse requirements for final uses, especially applications in aerospace industry.

TABLE 1
The producing fomular for composite materials
by bulk moulding compress process

| | Part for 100 wt. % of resin | | |
|---|---|---|---|
| | | Applications | |
| | | for high | |
| | Applications | ablation | |
| | for high | standing | Applications |
| | thermally | and thermal | of extremely |
| Ingredients | insulators | insulators | heat exposure |
| Phenolic resin | 28.0 | 30.0 | 24.0 |
| Peroxide organic | 0.2 | 0.3 | 0.2 |
| Zinc Stearate | 0.5 | 0.7 | 0.5 |
| Calcium carbonate | 50 | 5.7 | 50 |
| Clay | — | 20 | — |
| Ca(OH)₂ | 0.9 | 0.9 | 0.9 |
| Al(OH)₃ | — | 20 | — |
| Plastic powder | — | 2.4 | 3.5 |
| Glass fibre | 20.4 | 20 | 20.9 |

TABLE 2
Resin matrix used in composite producing
by bulk moudling compress technique

| Epoxy resin | Phenolic resin | Polyester resin |
|---|---|---|
| Consume 80% of total | Lower viscosity | High shrinkage |
| resin used in | High temperature | capacity (7-8%) |
| composite industry | Higher shrinkage | High chemical standing |
| Relatively high | capacity | ability |
| temperature | Volatile during | Density (g/cm³) 1.1- |
| Low shrinkage | curing process | 1.4 |
| capacity (2-3%) | High thermal | Modulus 1.3-4.1 GPa |
| Non-volatile during | standing | Tensile strength 40-85 |
| curing process | Anti-flame ability | MPa |
| Stable storage | Density (g/cm³) 1.2- | |
| Density (g/cm³) 1.1- | 1.4 | |
| 1.4 | Modulus 2.7-4.1 GPa | |
| Modulus 2.7-5.5 GPa | Tensile strength 35-60 | |
| Tensile strength 40- | MPa | |
| 85 MPa | | |

TABLE 3
Reinforcing fibre for composite producing with high thermal insulation
and high ablative standing by bulk moulding compress technique

| | | | |
|---|---|---|---|
| Reinforcing fibre | Density (g/cc) | Modulus (GPa) | Strength (GPa) |

Glass fibre

| | | | |
|---|---|---|---|
| E-glass | 2.55 | 65-75 | 2.2-2.6 |
| S-glass | 2.47 | 85-95 | 4.4-4.8 |

Aramid fibre

| | | | |
|---|---|---|---|
| Low modulus | 1.44 | 80-85 | 2.7-2.8 |
| Medium modulus | 1.44 | 120-128 | 2.7-2.8 |
| High modulus | 1.48 | 160-170 | 2.3-2.4 |

Carbon fibre

| | | | |
|---|---|---|---|
| Standard modulus | 1.77-1.80 | 220-240 | 3.0-3.5 |
| (High strength) | | | |
| Medium modulus | 1.77-1.81 | 270-300 | 5.4-5.7 |
| High modulus | 1.77-1.80 | 390-450 | 2.8-3.0 |
| | | | 4.0-4.5 |
| Super strength | 1.80-1.82 | 290-310 | 7.0-7.5 |

### 3. Ablation and Static-Pressure Testing

### 3.1 Ablation Testing

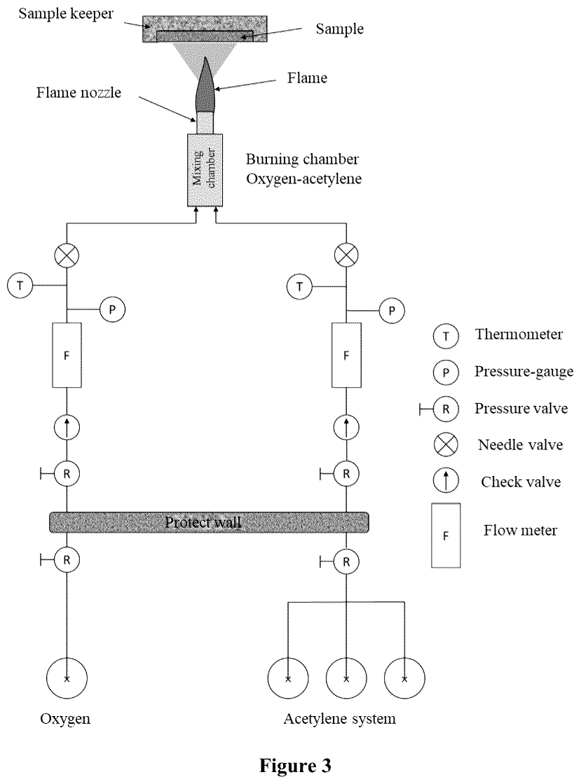

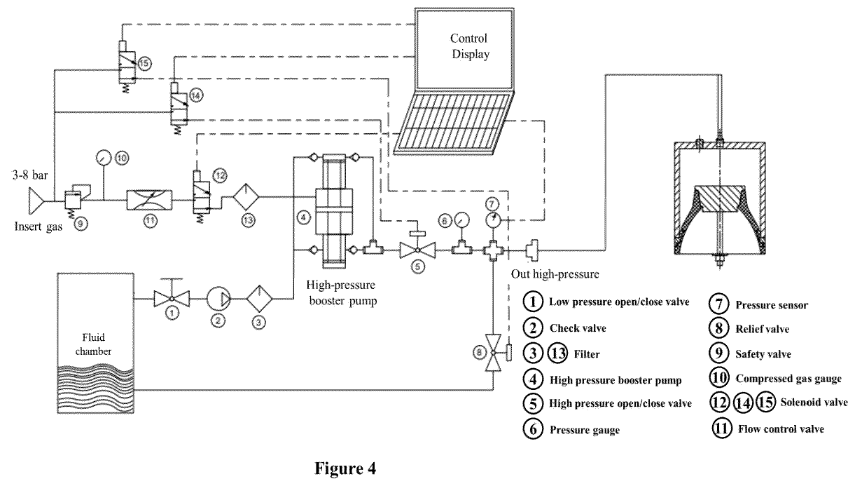

The product final composite material will be tested for evaluate the ablative standing under the heat application from Oxygen-Acetylene gun with the heat capacity being ˜835 W/cm², flow rate being 210 m/s with the neutral flame (Oxygen/Acetylene ˜1.2). The FIG. 3 depicts the testing system for ablation rate of composite material. The specimen for this test is a sample in flat shape, thickness is 6.35±0.41 mm. This thickness has to be measured and recorded in the information form in order to calculate the ablating rate. The flame source attacks the surface of the specimen until completely punctured. The period from beginning to the puncturing point is recorded for further evaluating.

Ablation rate of the composite material is calculated by the following formula:

$$E = d / b \qquad ( 1 )$$

Where, E is ablation rate (m/s), d is initial thickness of specimen (m), is period of completely puncturing (s).

For accuracy and reliability of the testing results, 5 specimens are tested and the results recorded separately. The ablation rate is the average of the 5 results that follow by the formula below:

$${E}_{a v g} = \sum E / N \qquad ( 2 )$$

Where, E_{avg} is the average ablation rate (m/s), ΣE is sum of ablation rate for all testing (m/s), N is the number of testings.

The standard deviation of the erosion rate coefficient is also a critical parameter that should be taken into consideration, as it provides an assessment of the uniformity in erosion behavior and the reliability of the testing method. The erosion rate standard deviation is calculated using the following formula:

$${S}_{E} = \sqrt{\sum {[ E - ( {E}_{a v g} ) ]}^{2} / ( N - 1 )} \qquad ( 3 )$$

Where, S_{E} is the standard deviation of the erosion rate coefficient; E_{avg} is the average erosion rate coefficient (m/s); E is the erosion rate coefficient for each individual measurement (m/s); N is the number of test repetitions.

### 3.2 Static-Pressure Testing

After fabrication, composite material components-such as motor casings, solid rocket motor nozzles, and other structural parts-must undergo mechanical strength and destructive testing to ensure compliance with required mechanical properties. The method employed to evaluate these technical criteria is hydrostatic pressure testing or pneumatic pressure testing. The equipment system for this testing method comprises the following specialized groups:
Oil Supply Unit: Comprising an oil reservoir, pump, piping system, and control valves, this unit functions to supply and discharge the test medium to and from the system.
Measurement and Fixture Unit: Including fixtures, support jigs, and pressure-tight test caps, this unit is responsible for securing the test specimen, integrating with the overall test setup, and ensuring operational safety during testing.
Data Acquisition and Display Unit: Comprising pressure gauges and a data acquisition (DAQ) system, this unit collects real-time pressure-time data throughout the testing process and records the output signals for result evaluation.

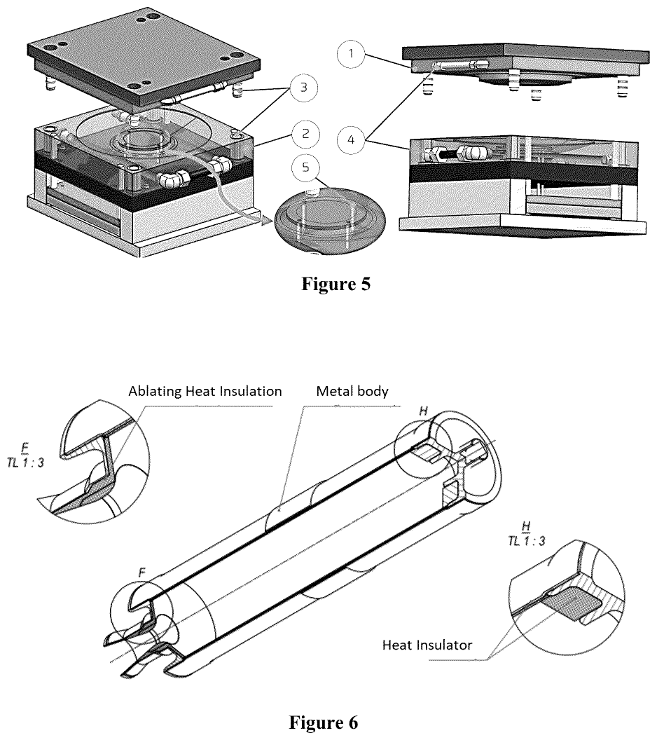

The static pressure strength test is conducted by initially measuring the dimensions at predetermined critical locations on the test component, typically at areas with minimal wall thickness. Following the initial measurements, any residual or trapped air within the pressurization chamber is automatically purged through the oil system and vent valves. The FIG. 5 illustrates the system for static-pressure test in the scale of this invention.

The design of mould for bulk molding compound technique includes:
(1) Upper mould
(2) Lower mould
(3) Guide component
(4) Heating system
(5) Product pushing pin

Once the excess air has been fully discharged, internal pressure is gradually increased until it reaches the specified target value and is maintained at that level for a duration of 10 seconds. Upon completion of the pressure holding phase, the test fixture is disassembled, and the same locations are re-measured to assess any dimensional changes. Based on the comparison of pre- and post-test dimensions, the pressure resistance of the component is evaluated.

The invention is described in detail for the technology of manufacturing composite material by bulk injection molding method as above. However, it is clear that the person of ordinary skill in the field of invention is not limited to the embodiment described in the description of the invention. The invention may be implemented in modified or modified mode without falling outside the scope of the invention as defined by the claims. Therefore what is described in the description of the invention is for illustrative purposes only, and shall not impose any limitations on the invention.

1. A process of composite materials production, comprising the steps of:
Step 1: Prepare raw materials with a purpose of listing and separate materials, get ready for scaling and mixing;
Step 2: Scale the raw materials based on an indicated formula;
Step 3: Premix the raw materials by group: Resin and catalyst, additives, chopped reinforced fibre;
Step 4: Mix all premixed materials into uniformed substance in a central chamber to produce an initial bulk materials;
Step 5: Extrude to form bulk materials, increase a density, avoid bubble inside materials, prepare for a compress molding step;
Step 6: Storing the bulk materials in a warehouse with optimal storage conditions, ready for molding;
Step 7: Bulk molding compounds compress processing to produce material parts, release mould and machining to obtained final products.

2. The process according to claim 1, wherein:
a temperature for the central chamber is (50-60)° C., a mixing duration comprises (15-20) minutes;
the raw materials are chosen from Table 1;
TABLE 1

| | Part for 100 wt. % of resin | | |
|---|---|---|---|
| | | Applications | |
| | | for high | |
| | Applications | ablation | |
| | for high | standing | Applications |
| | thermally | and thermal | of extremely |
| Ingredients | insulators | insulators | heat exposure |
| Phenolic resin | 28.0 | 30.0 | 24.0 |
| Peroxide organic | 0.2 | 0.3 | 0.2 |
| Zinc Stearate | 0.5 | 0.7 | 0.5 |
| Calcium carbonate | 50 | 5.7 | 50 |
| Clay | — | 20 | — |
| Ca(OH)₂ | 0.9 | 0.9 | 0.9 |
| Al(OH)₃ | — | 20 | — |
| Plastic powder | — | 2.4 | 3.5 |
| Glass fibre | 20.4 | 20 | 20.9 |

resin matrices are phenolic, epoxy, polyester with specifications indicated in Table 2;
TABLE 2

| Epoxy resin | Phenolic resin | Polyester resin |
|---|---|---|
| Consume 80% of total | Lower viscosity | High shrinkage |
| resin used in | High temperature | capacity (7-8%) |
| composite industry | Higher shrinkage | High chemical standing |
| Relatively high | capacity | ability |
| temperature | Volatile during | Density (g/cm³) 1.1- |
| Low shrinkage | curing process | 1.4 |
| capacity (2-3%) | High thermal | Modulus 1.3-4.1 GPa |
| Non-volatile during | standing | Tensile strength 40-85 |
| curing process | Anti-flame ability | MPa |
| Stable storage | Density (g/cm³) 1.2- | |
| Density (g/cm³) 1.1- | 1.4 | |
| 1.4 | Modulus 2.7-4.1 GPa | |
| Modulus 2.7-5.5 GPa | Tensile strength 35-60 | |
| Tensile strength 40- | MPa | |
| 85 MPa | | |

The chopped reinforced fibre has length of 6.5 mm with characteristic indicated in Table 3;
TABLE 3

| | | | |
|---|---|---|---|
| Reinforcing fibre | Density (g/cc) | Modulus (GPa) | Strength (GPa) |

Glass fibre

| | | | |
|---|---|---|---|
| E-glass | 2.55 | 65-75 | 2.2-2.6 |
| S-glass | 2.47 | 85-95 | 4.4-4.8 |

Aramid fibre

| | | | |
|---|---|---|---|
| Low modulus | 1.44 | 80-85 | 2.7-2.8 |
| Medium modulus | 1.44 | 120-128 | 2.7-2.8 |
| High modulus | 1.48 | 160-170 | 2.3-2.4 |

Carbon fibre

| | | | |
|---|---|---|---|
| Standard modulus | 1.77-1.80 | 220-240 | 3.0-3.5 |
| (High strength) | | | |
| Medium modulus | 1.77-1.81 | 270-300 | 5.4-5.7 |
| High modulus | 1.77-1.80 | 390-450 | 2.8-3.0 |
| | | | 4.0-4.5 |
| Super strength | 1.80-1.82 | 290-310 | 7.0-7.5. |

3. The process according to claim 1, further comprising testing of ablation and static-pressure, comprising:
using a heat source of oxy-acetylene with technical specifications of heat capacity being ˜835 W/cm², flow rate being 210 m/s with the neutral flame (Oxygen/Acetylene ˜1.2); and
static-pressure testing using compressed air or hydraulic pressure taking initial measurement dimensions at predetermined critical locations on a test component, typically at areas with minimal wall thickness, following the initial measurements, purging any residual or trapped air within the pressurization chamber;
the air has been fully purged, gradually increasing internal pressure until it reaches a specified target value and maintaining at that level for a duration of 10 seconds;
disassembling the test fixture is disassembled, remeasuring at the predetermined critical locations to assess any dimensional changes;
evaluating the pressure resistance of the component based on a comparison of pre- and post-test dimensions.
